(19) United States
(12) Patent Application Publication
(10) Pub. No.: US 2014/0271985 A1
(43) Pub. Date: Sep. 18, 2014

(54) CHEWING GUM SNACKS; AND METHODS OF MAKING THEREOF

(71) Applicant: INTERCONTINENTAL GREAT BRANDS LLC, East Hanover, NJ (US)

(72) Inventors: Francis Amoako-Poku, Whippany, NJ (US); Susan Pettigrew, Whippany, NJ (US); Doris Tancredi, Whippany, NJ (US); Zi Yang, Whippany, NJ (US)

(21) Appl. No.: 14/210,502

(22) Filed: Mar. 14, 2014

Related U.S. Application Data
(60) Provisional application No. 61/782,711, filed on Mar. 14, 2013.

(51) Int. Cl. A23G 4/20

(52) U.S. Cl. CPC A23G 4/20; A23V 2200/14
USPC 426/5; 426/3

(57) ABSTRACT

Disclosed herein are chewing gum snack products having multi-sensorial attributes of flavor, texture, and visual appeal which provides a snack-like quality at the initial stage of chewing that then transitions to chewing gum-like qualities at later stages of chewing.

### CROSS REFERENCE TO RELATED APPLICATION

This application claims the benefit of U.S. Provisional Application No. 61/782,711 filed Mar. 14, 2013, which is hereby incorporated by reference in its entirety.

### BACKGROUND

Snacking is generally eating foodstuff between regular meals (breakfast, lunch, dinner) typically with a portion size smaller than regular meals. Snack foods are eaten for a variety of reasons involving internal motivations (boredom, tired, stressed, hungry, etc.) and external motivations (special occasions, celebrations, while the kids are snacking, while watching television, socializing, etc.).

Taste is an important factor in snacking with consumers targeting sweet, salty, or savory snacks depending upon their needs.

Certain trends in the selection of snacks have been found depending upon the consumer's emotional needs at the time of snacking:

Hunger—savory snacks;

Content or happy—satisfy a craving with something sweet, quick, inexpensive and will not spoil appetite;

Rushed or busy—quick, easy, readily available and will provide energy;

Boredom—salty foods and/or those with a crunchy texture; and

Stressed—cookies and chocolate.

Chewing gum is popular with consumers for its ability to provide a long lasting chew experience. Traditional chewing gums include the common uncoated, slab and stick formats, hard coated pellet, and gum ball formats. Consumers readily identify such products as chewing gum and not as snacks. Furthermore, chewing traditional chewing gum provides a cohesive chew. By the action of chewing, saliva is created, which is swallowed. However, the experience of chewing traditional chewing gums does not provide the consumer with the feeling of swallowing a food product such as when consuming a snack product.

Altogether, traditional chewing gums are perceived by consumers, visually and texturally, as chewing gum. Consumers also do not find current chewing gums as sufficient to meet their snacking needs.

There remains a need in the art for new chewing gum that can deliver a more satisfying snack-like quality in addition to chewing gum qualities.

### SUMMARY

In an embodiment, a multi-textured chewing gum snack product comprises a.) a chewing gum composition portion and a confectionery composition portion, the chewing gum composition portion having a different texture than the confectionery composition portion; or b.) a first chewing gum composition portion and a second chewing gum composition portion, the first chewing gum composition portion having a different composition and different texture than the second chewing gum composition portion; and the multi-textured chewing gum snack product has a candy-like impression rating upon initial chewing that is at least 20 points greater than a candy-like impression rating of a chewing gum slab based on a scale of 0 to 100 as measured by descriptive analysis using the Quantitative Descriptive Analysis method.

In an embodiment, a multi-textured chewing gum snack product comprises a.) a chewing gum composition portion and a confectionery composition portion, the chewing gum composition portion having a different texture than the confectionery composition portion; or b.) a first chewing gum composition portion and a second chewing gum composition portion, the first chewing gum composition portion having a different composition and different texture than the second chewing gum composition portion; and the multi-textured chewing gum snack product has a candy-like impression rating of 35 to 100 upon initial chewing based on a scale of 0 to 100 as measured by descriptive analysis using the Quantitative Descriptive Analysis method where a traditional slab chewing gum that is monolithic and monotextured and prepared from sorbitol, gum base, glycerol, natural and artificial flavors, less than 2% of hydrogenated starch hydrolysate, aspartame, aspartame-acesulfame, mannitol, soy lecithin, acesulfame K, colors, and butylated hydroxytoluene is given a rating of 10 and a multi-textured chewing gum snack product according to Example 3 is given a rating of 75.

In an embodiment, a multi-textured chewing gum snack product comprises a.) a chewing gum composition portion and a confectionery composition portion, the chewing gum composition portion having a different texture than the confectionery composition portion; or b.) a first chewing gum composition portion and a second chewing gum composition portion, the first chewing gum composition portion having a different composition and different texture than the second chewing gum composition portion; and the multi-textured chewing gum snack product has a candy-like impression rating of 20 to 100 upon initial chewing based on a scale of 0 to 100 as measured by descriptive analysis using the Quantitative Descriptive Analysis method where a traditional slab chewing gum that is monolithic and monotextured and prepared from sorbitol, gum base, glycerol, natural and artificial flavors, less than 2% of hydrogenated starch hydrolysate, aspartame, aspartame-acesulfame, mannitol, soy lecithin, acesulfame K, colors, and butylated hydroxytoluene is given a rating of 10 and a multi-textured chewing gum snack product according to Example 3 is given a rating of 75; wherein a region of the chewing gum composition portion is exposed.

In an embodiment, a multi-textured chewing gum snack product comprises a.) a chewing gum composition portion and a confectionery composition portion, the chewing gum composition portion having a different texture than the confectionery composition portion; or b.) a first chewing gum composition portion and a second chewing gum composition portion, the first chewing gum composition portion having a different composition and different texture than the second chewing gum composition portion; and wherein the multi-textured chewing gum snack product exhibits a peak bend force of greater than 400 g-force as measured using a three point bend test.

In an embodiment, a multi-textured chewing gum snack product comprises a.) a chewing gum composition portion and a confectionery composition portion, the chewing gum composition portion having a different texture than the confectionery composition portion; or b.) a first chewing gum composition portion and a second chewing gum composition portion, the first chewing gum composition portion having a different composition and different texture than the second chewing gum composition portion; and after chewing the multi-textured chewing gum snack product for ten minutes results in a bolus size that is about 5 to about 15 wt % of the total starting weight of the multi-textured chewing gum snack product prior to chewing, optionally where a region of the chewing gum composition portion is exposed.

In an embodiment, a multi-textured chewing gum snack product comprises a.) a chewing gum composition portion and a confectionery composition portion, the chewing gum composition portion having a different texture than the confectionery composition portion; or b.) a first chewing gum composition portion and a second chewing gum composition portion, the first chewing gum composition portion having a different composition and different texture than the second chewing gum composition portion; and the multi-textured chewing gum snack product provides a sensory impression of consuming a snack product upon initial chewing, which transitions over a period of less than 120 seconds of chewing into a sensory impression of chewing a chewing gum; and a region of the chewing gum composition portion is exposed.

The above described and other features are exemplified by the following detailed description.

### DETAILED DESCRIPTION

Disclosed herein are chewing gum snack products (also referred to as “multi-textured chewing gum snack products”) that deliver a snack-like eating experience not achieved by traditional slab, stick, and coated pellet chewing gums. By combining in a single product a chewing gum composition portion and a confectionery composition portion, or two different chewing gum composition portions, each portion having certain textures and flavors, a product is created that exhibits multi-sensory attributes (textural, appearance, flavor, and the like) leading to an emotionally satisfying snack-like eating experience for the consumer. Products with multiple textures, multiple flavors, and a snack-like appearance were found to engage the consumer and provide a snack-like eating experience, thus meeting various snacking needs of a consumer.

When chewed, the chewing gum snack products have initial sensory attributes reminiscent of chewing a snack product with a sensation of swallowing and upon continued chewing transforms over a period of time to sensory attributes of a chewing gum. Unlike traditional chewing gum, the chewing gum snack product is capable of satisfying a consumer's snacking urge.

Consumers seek emotional and sensory satisfaction when snacking and seek to compensate, maintain, or enhance mood. Sensory attributes of the chewing gum snack product can meet these needs. Snacks with an initial crunch or snacks with a crunchy/chewy combination can help people compensate or rebalance when stressed, tired, or bored. Snacks with a crunchy/chewy combination can help a consumer maintain (“keep on going”) whether in a high or low energy state. Smooth, non-crunchy, or moderately crunchy snacks and snacks with fruity and indulgent flavors are enhancing an emotional state, adding to the moment to make a happy occasion happier, a relaxing moment more enjoyable, etc.

As the urge to snack is often linked to an emotional state of the consumer, the use of multi-sensorial chewing gum snack products can be used to satisfy the snacking vulnerability with their multitextured property, visual appeal, and flavor/aroma. Those products delivering a type of emotional satisfaction were strong in visual appeal, identifiable as food (which made them appear different than traditional chewing gum), maintained the consumer's interest, and having a visual identity that matches the flavor and texture experience. The flavor for these products is intense fruit or brown flavors, different flavors for different components of the product, long-lasting and meets expectations for character and intensity based on the products' appearance. The texture for these products meets expectations based on visual cues, does not fall apart during transition from initial chew of a snack to the final chew as a chewing gum. The product has a defined snack phase such that it is not immediately perceived as a chewing gum upon initial chew. The texture of the snack phase smoothly transitions to the chewing gum phase such that the consumer does not perceive physically separate snack pieces and chewing gum pieces in the mouth at the same time after the transition.

The multi-textured chewing gum snack product has visual characteristics of a snack food. The unique sensory attributes derived from the multi-textural qualities and flavor of the chewing gum product combined with the visual cues informs the consumer that the product is more than a traditional chewing gum. Attributes that make the product more snack-like include a combination of flavor and texture attributes as well sensation of swallowing.

Flavor attributes contributing to a snack-like perception include aromatic, brown flavors and fruit flavors.

Texture attributes contributing to a snack-like perception include crunchy, crumble, particulates, and the like, as well as different textures within the same product. Mouthfeel attributes contributing to a snack-like perception include melting/dissolvability, creaminess, mouth coating, and the like.

Also contributing to snack-like characteristics is a transition of texture from initial chew to a final chew. The initial chew experience is similar to a swallowable snack food product yet with further chewing transitions into a product having a chew experience like that of chewing gum. The transition time from a snack-like texture to a chewing gum-like texture occurs over a period of time sufficient so that the consumer perceives both textures.

In an embodiment, the multi-textured chewing gum snack product provides an initial crunchy or crispy texture that then transitions into a cohesive chewing texture upon continued chewing.

The term “confectionery” excludes chewing gum or compositions containing gum base or gum base polymers. If a composition contains gum base or a gum base polymer it will be characterized herein as “chewing gum”.

In an embodiment, the confectionery composition portion or a first or second chewing gum composition portion of the multi-textured chewing gum snack product provides an initial creamy mouthfeel, crunchy, crispy, soft, grainy, or smooth texture.

The chewing gum snack product provides a consumer with the sensation of swallowing a snack food during the initial chew process, the sensation of swallowing a snack food is distinct from the sensation of swallowing increased amounts of saliva that may occur from chewing traditional chewing gum. The chewing gum snack product further exhibits a change in bolus size during consumption that contributes to the snack-like characteristic. Transitioning from a large bolus size at the initial chew to a small bolus size at the final stage of chewing is accompanied by the sensation of swallowing a snack food, specifically swallowing of the confectionery composition portion or the water soluble ingredients of the first or second chewing gum composition portion.

In an embodiment, a multi-textured chewing gum snack product comprises a chewing gum composition portion and a confectionery composition portion, and optionally one or more additional chewing gum composition portions, one or more additional confectionery composition portions, or a combination thereof. In another embodiment, a multi-textured chewing gum snack product comprises a first chewing gum composition portion and a second chewing gum composition portion which have different compositions, and optionally one or more additional chewing gum composition portions.

Within the multi-textured chewing gum snack product, the chewing gum composition portion and the confectionery composition portion have different textures. Within the multi-textured chewing gum snack product, the first chewing gum composition portion and the second chewing gum composition portion have different compositions and different textures. If more than one chewing gum composition or confectionery composition portions are present, each portion can have different textures or similar textures as long as the texture of one chewing gum composition portion is different from one confectionery composition portion, or as long as the texture of the first chewing gum composition portion is different from the second chewing gum composition portion.

In an embodiment, the chewing gum snack product has a non uniform cross section.

In an embodiment, the chewing gum snack product is nonhomogeneous.

The multi-textured chewing gum snack product has different regions of chewing gum and confectionery or different regions of different chewing gum compositions. In an embodiment, at least one chewing gum composition portion is visually distinct from one confectionery composition portion, specifically each chewing gum composition portion and each confectionery composition portion are visually distinct from one another. In an embodiment, the first chewing gum composition portion is visually distinct from the second chewing gum composition portion.

In an embodiment, at least one chewing gum composition portion has a different color than one confectionery composition portion, specifically each chewing gum composition portion and each confectionery composition portion have different colors from one another. In an embodiment, the first chewing gum composition portion has a different color than the second chewing gum composition portion.

In an embodiment, at least one chewing gum composition portion has a different shape, size, or a combination thereof from one confectionery composition portion, specifically each chewing gum composition portion and each confectionery composition portion have different shapes, sizes, or a combination thereof. In an embodiment, the first chewing gum composition portion has a different shape, size, or a combination thereof than the second chewing gum composition portion.

In an embodiment, at least one chewing gum composition portion has a different flavor from at least one confectionery composition portion, where each flavor is a fruit, a brown, a spice, a savory, or a combination thereof, specifically a brown flavor. In an embodiment, the first chewing gum composition portion has a different flavor than the second chewing gum composition portion, where each flavor is a fruit, a brown, a spice, a savory, or a combination thereof, specifically a brown flavor.

In an embodiment, the chewing gum snack product is breakable into sections, thereby capable of providing a hand to mouth interaction, again cuing the consumer that the multi-textured chewing gum snack product is more than a chewing gum.

In an embodiment, the confectionery composition portion allows for the product to have a degree of fracture, where the confectionery composition portion breaks into separate pieces when bent 90 degrees.

In an embodiment, the multi-textured chewing gum snack product can have a weight ratio of total chewing gum composition portion to total confectionery composition portion of about 10:90 to about 90:10, specifically about 20:80 to about 80:20, more specifically about 30:70 to about 70:30, and yet more specifically about 40:60 to about 60:40.

### Chewing Gum Composition Portion

In general the chewing gum composition of the chewing gum composition portion comprises a gum base and a bulk sweetener or a gum base polymer and a bulk sweetener. When combined with the gum base or gum base polymer, the bulk sweetener can be in powdered form or in molten form depending upon the desired texture of the chewing gum composition.

The bulk sweetener of the chewing gum composition can be a sugar-based or sugar-free bulk sweetener, specifically sugar-free. Bulk sugar sweeteners generally include saccharides. Suitable sugar sweeteners include mono-saccharides, di-saccharides and poly-saccharides, for example, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids, such as high fructose corn syrup, or a combination thereof.

The bulk sweetener can also be a sugar-free bulk sweetener such as a sugar alcohol, also referred to as a “sugar polyol”. The sugar alcohol can be erythritol, galactitol, isomalt, a hydrogenated starch hydrolyzate, lactitol, maltitol, mannitol, polyglycitol, sorbitol, xylitol, and the like, or a combination thereof. The sugar alcohol can be in powdered or particulate form (either crystalline or amorphous), molten (melted) form having a low moisture content (e.g. less than 10 wt %, specifically less than 5 wt %), or in syrup form (also referred to as “solution”) with water. Exemplary sugar alcohol syrups include sorbitol syrup, maltitol syrup, hydrogenated starch hydro lysate syrup, polyglycitol syrup, and the like.

The amount of bulk sweetener in the chewing gum composition can be about 1 to about 85 wt % based on the total weight of the chewing gum composition, specifically about 10 to about 75 wt %, more specifically about 20 to about 65 wt %, yet more specifically about 30 to about 55 wt %, and yet more specifically about 40 to about 45 wt %.

In an embodiment, the chewing gum composition is sugar-free.

The chewing gum may further comprise an additional ingredient wherein the additional ingredient is a flavorant, a fat, a high intensity sweetener, a food acid or salt thereof, a sensate, a flavor modulator or potentiator, a coloring agent, a humectant, a salt, a softener, or a combination thereof.

Exemplary flavorants (flavor, flavoring agent) for use in the chewing gum composition can include those artificial or natural flavors known in the art, for example synthetic flavor oils, natural flavoring aromatics and/or oils, oleoresins, extracts derived from plants, leaves, flowers, fruits, and the like, or a combination thereof. Nonlimiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, or a combination thereof.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin).

Specific flavors suitable for conveying a snack-like quality include fruit, brown, and spice notes, or a combination thereof. Brown flavors include chocolate, butterscotch, caramel, toffee, vanilla, nutty, coffee notes, or a combination thereof. Spice flavors include cinnamon, nutmeg, aniseed, and the like.

The flavorant can be used in liquid or solid form. The flavorant can be used in free form or encapsulated form. When used in solid (dry) form, suitable drying means such as spray drying a flavor oil can be used. Alternatively, the flavorant can be encapsulated, absorbed onto water soluble materials by means known in the art, for example cellulose, starch, sugar, maltodextrin, gum arabic, and the like. In an embodiment, the flavorant can be used in physical forms effective to provide an initial burst of flavor or a prolonged sensation of flavor.

More than one flavorant can be used in the composition. The amount and type of flavorant can be chosen based on the targeted release profile and flavor intensity desired. The chewing gum composition generally comprises a flavorant in an amount of about 0.001 to about 5 wt % based on the total weight of the chewing gum composition, specifically about 0.01 to about 4 wt %, yet more specifically about 0.1 to about 3 wt %, and still yet more specifically about 1.0 to about 2 wt %.

The chewing gum composition may further contain a high intensity sweetener. A “high intensity sweetener” as used herein means agents having a sweetness greater than the sweetness of sucrose. In an embodiment, a high intensity sweetener has a sweetness that is at least 100 times that of sugar (sucrose) on a per weight basis, specifically at least 500 times that of sugar on a per weight basis. In an embodiment the high intensity sweetener is at least 1,000 times that of sugar on a per weight basis, more specifically at least 5,000 times that of sugar on a per weight basis. The high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Combinations comprising one or more sweeteners or one or more of the foregoing types of sweeteners can be used. Without being limited to particular sweeteners, representative categories and examples include:

water-soluble sweetening agents such as dihydrochalcones, monellin, steviosides, rebaudiosides, glycyrrhizin, dihydroflavenol, monatin, and L-aminodicarboxylic acid aminoalkenoic acid ester amides, such as those disclosed in U.S. Pat. No. 4,619,834, or a combination thereof;

water-soluble artificial sweeteners such as soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, or a combination thereof; dipeptide based sweeteners, for example the L-aspartic acid derived sweeteners such as L-aspartyl-L-phenylalanine methyl ester (Aspartame) and materials described in U.S. Pat. No. 3,492,131, L-alpha-aspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, neotame, or a combination thereof;

water-soluble sweeteners derived from naturally occurring water-soluble sweeteners, such as steviosides and stevia derived compounds, for example, steviol glycosides such as rebaudiocides including rebaudiocide A, and the like, lo han quo and lo han quo derived compounds such as iso-mogroside V and the like, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include, for example: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro4,6,1′,6′-tetradeoxygalacto-sucrose; 4,6,1′,6′-tetradeoxy-sucrose, or a combination thereof;

protein based sweeteners such as thaumaoccous danielli, talin, or a combination thereof; and

amino acid based sweeteners.

Furthermore, the high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, or a combination thereof.

The chewing gum composition can contain a fat which can provide textural attributes and a mouth coating feeling when the chewing gum snack product is consumed. Exemplary fats for use in the chewing gum composition include fats and oils of vegetable origin, animal origin, or a combination thereof. Suitable vegetable fats can include soybean, cottonseed, corn, almond, peanut, sunflower, rapeseed, olive, palm, palm kernel, illipe, shea, coconut, cocoa, cocoa butter, or a combination thereof. The forgoing vegetable fats can be hydrogenated to varying degrees as desired or separated by fractional crystallization. Suitable animal fats include dairy fats such as milk fat and butter. As used herein, the term “fat” refers to any lipid material and can be solid or liquid (e.g. oil). Exemplary lipid materials include triglycerides, fatty alcohols, fatty acids, or a combination thereof. The triglyceride is not limited although medium chain triglycerides, long chain triglycerides, and the like can be used. The melting point of the fat is not limited although fats having a melting point of about 15 to about 68° C. can be used. Specific fats include hydrogenated palm oil, hydrogenated palm kernel oil, hydrogenated soybean oil, hydrogenated peanut oil, hydrogenated cottonseed oil, hydrogenated coconut oil, or a combination thereof. In an embodiment, the chewing gum composition contains a low melting point fat, having a melting point of about 15 to about 50° C.

A fat can be present in the chewing gum composition in an amount of about 0.1 to about 25 wt % based on the total weight of the chewing gum composition, specifically about 1.0 to about 15, and more specifically about 5 to about 10 wt %.

The chewing gum composition may optionally further comprise a coloring agent. Coloring agents (colors, colorants, colorings) can be used in amounts effective to produce a desired color for the chewing gum. Suitable coloring agents include pigments, which can be incorporated in amounts up to about 6 wt % based on the total weight of the chewing gum. For example, titanium dioxide can be incorporated in amounts up to about 2 wt %, and specifically less than about 1 wt % based on the total weight of the chewing gum. Suitable coloring agents also include natural food colors and dyes suitable for food, drug, and cosmetic applications.

Suitable colors include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), or a combination thereof. In an embodiment, certified colors can include FD&C aluminum lakes, or a combination thereof. A full recitation of all FD& C colorants and their corresponding chemical structures may be found in the Kirk-Othmer Encyclopedia of Chemical Technology, 4th Edition, in volume 1 at pages 492-494.

Exemplary food acids or salts thereof for use in the chewing gum can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and alkali metal salts thereof (e.g., sodium citrate dihydrate), or a combination thereof. The food acid or salt thereof may be used in free form or in an encapsulated form.

The chewing gum composition may comprise a sensate. Exemplary sensates include cooling agents, warming agents, tingling agents, effervescent agents, or a combination thereof.

The chewing gum composition may optionally further comprise a flavor modulator or potentiator. A sweet taste can come from flavor modulators or potentiators and/or from flavorants as well as from sweeteners. Flavor potentiators can consist of materials that intensify, supplement, modify or enhance the taste or aroma perception of an original material without introducing a characteristic taste or aroma perception of their own. Flavor modulators can impart a characteristic of their own that complements or negates a characteristic of another component. In an embodiment, flavor modulators or potentiators are designed to intensify, supplement, modify, or enhance the perception of flavor, sweetness, tartness, umami, kokumi, saltiness or a combination thereof can be included. Thus, the addition of flavor modulators or potentiators can impact the overall taste of the chewing gum. For example, flavors can be compounded to have additional sweet notes by the inclusion of flavor modulators or potentiators, such as vanilla, vanillin, ethyl maltol, furfual, ethyl propionate, lactones, or a combination thereof.

Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), or a combination thereof. In an embodiment, sugar acids, sodium chloride, potassium chloride, sodium acid sulfate, or a combination thereof are used. In an embodiment, glutamates such as monosodium glutamate, monopotassium glutamate, hydrolyzed vegetable protein, hydrolyzed animal protein, yeast extract, or a combination thereof are included. Further examples include adenosine monophosphate (AMP), glutathione, and nucleotides such as inosine monophosphate, disodium inosinate, xanthosine monophosphate, guanylate monophosphate, or a combination thereof. Further examples of flavor potentiator compositions that impart kokumi are also included in U.S. Pat. No. 5,679,397 to Kuroda et al.

The amount of flavor modulators, flavor potentiators, and flavorants used herein can be a matter of preference subject to such factors as the type of final product composition, the individual flavor, and the strength of flavor desired. Thus, the amount of flavoring can be varied in order to obtain the result desired in the final product and such variations are within the capabilities of those skilled in the art without the need for undue experimentation.

The chewing gum composition may optionally further comprise an amount of a salt, specifically sodium chloride, to provide a salty/sweet flavor in the presence of the bulk sweetener or high intensity sweetener. Amounts of salt present in the chewing gum composition can be about 0.001 to about 0.5 wt % based on the total weight of the chewing gum composition, specifically about 0.01 to about 0.1 wt %, and more specifically about 0.04 to about 0.07 wt %.

The chewing gum composition may optionally further comprise a humectant. Exemplary humectants include glycerin, propylene glycol, polyethylene glycol, or a combination thereof. The amount of humectant can be controlled to ensure the final chewing gum product does not unduly absorb moisture from the surrounding environment during production, packaging, storage, and use.

The chewing gum composition may further include a softener, such as those described herein for use in the gum base.

Another ingredient that can be added to the chewing gum composition includes a bicarbonate salt, such as sodium bicarbonate, which can provide aeration to the composition when the composition is heated to a temperature above 120° C.

The chewing gum composition comprises a chewing gum base. In an embodiment, the chewing gum comprises a gum base comprising an elastomer and optionally an additional gum base ingredient, wherein the additional gum base ingredient is a resin, a fat, an emulsifier, a wax, a filler, a softener, a plasticizer, an antioxidant, or a combination thereof.

As used herein, the term “gum base” refers to water insoluble material(s) and can include, for example, elastomers, resins, waxes, elastomer solvents, emulsifiers, plasticizers, bulking agents/fillers, or a combination thereof.

The amount of gum base employed will vary depending upon various factors such as the type of base used, the consistency of the chewing gum desired, and the other components used in the composition to make the final chewing gum product. In general, the gum base will be present in amounts of about 5 to about 65 wt % based on the total weight of the chewing gum composition, specifically about 10 to about 55 wt %, more specifically about 15 to about 45 wt %, and yet more specifically about 20 to about 35 wt %.

Exemplary elastomers to be used in the chewing gum base include both natural and synthetic elastomers and rubbers, for example, substances of vegetable origin such as chicle, crown gum, nispero, rosadinha, jelutong, perillo, niger gutta, tunu, balata, gutta-percha, lechi-capsi, sorva, gutta kay, and the like, or a combination thereof. Synthetic elastomers such as butadiene-styrene copolymers, polyisobutylene, isobutyleneisoprene copolymers, polyethylene, a combination thereof, and the like, or a combination thereof are also useful. The gum base can include a non-toxic vinyl polymer, such as polyvinyl acetate and its partial hydrolysate, polyvinyl alcohol, or a combination thereof. When utilized, the molecular weight of the vinyl polymer can range from about 3,000 up to and including about 94,000. Additional useful polymers include: crosslinked polyvinyl pyrrolidone, polymethylmethacrylate; copolymers of lactic acid, polyhydroxyalkanoates, plasticized ethylcellulose, polyvinyl acetatephthalate, or a combination thereof.

Conventional additives can be included in the gum base in effective amounts such as plasticizers or softeners to provide a variety of desirable textures and consistency properties. Because of the low molecular weight of these components, the plasticizers and softeners are able to penetrate the fundamental structure of the gum base making it plastic and less viscous. Suitable plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerin, or a combination thereof. Some of these ingredients may be added at the time of gum base formation or added later during the production of the chewing gum composition.

Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, and the like, or a combination thereof, can also be incorporated into the gum base to obtain a variety of desirable textures and consistency properties.

When a wax is present in the gum base, it softens the polymeric elastomer mixture and improves the elasticity of the gum base. The waxes employed may have a melting point below about 60° C., and specifically between about 45° C. and about 55° C. The low melting wax can be a paraffin wax. The wax can be present in the gum base in an amount of about 0.1 to about 10 wt %, and specifically about 3 to about 7 wt % based on the total weight of the gum base.

In addition to the low melting point waxes, waxes having a higher melting point can be used in the gum base in amounts up to about 5 wt % based on the total weight of the gum base. Such high melting waxes include beeswax, vegetable wax, candelilla wax, carnuba wax, most petroleum waxes, and the like, or a combination thereof.

The gum base can optionally contain conventional elastomer solvents to aid in softening the elastomer base component, for example resins such as polymers of alpha-pinene or beta-pinene; methyl, glycerol or pentaerythritol esters of rosins or modified rosins and gums, such as hydrogenated, dimerized or polymerized rosins, or a combination thereof; the pentaerythritol ester of partially hydrogenated wood or gum rosin; the pentaerythritol ester of wood or gum rosin; the glycerol ester of wood rosin; the glycerol ester of partially dimerized wood or gum rosin; the glycerol ester of polymerized wood or gum rosin; the glycerol ester of tall oil rosin; the glycerol ester of wood or gum rosin; the partially hydrogenated wood or gum rosin; the partially hydrogenated methyl ester of wood or rosin; and the like; or a combination thereof. The elastomer solvent can be used in amounts of about 5 to about 75 wt % base on the total weight of the gum base, and specifically about 45 to about 70 wt %.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate, tricalcium phosphate and the like, or a combination thereof. These fillers or adjuvants can be used in the gum base in various amounts. Specifically the amount of filler, when used, can be present in an amount of greater than about 5 to about 60 wt % based on the total weight of the gum base, and more specifically from about 20 to about 30 wt %.

Suitable emulsifiers for use in the gum base include distilled monoglycerides, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate, glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, tweens, spans, stearoyl lactylates, calcium stearoyl-2-lactylate, sodium stearoyl-2-lactylate, lecithin, ammonium phosphatide, sucrose esters of fatty acids, sucroglycerides, propane-1,2-diol esters of fatty acids, or a combination thereof.

The chewing gum composition can be prepared using standard techniques and equipment known in the art.

In one exemplary process, a gum base is heated to a temperature sufficiently high to soften the gum base without adversely affecting the physical and chemical make up of the gum base, which will vary depending upon the composition of the gum base used, and is readily determined by those skilled in the art without undue experimentation. For example, the gum base can be conventionally melted to about 60° C. to about 160° C., or melted to about 150° C. to about 175° C., for a period of time sufficient to render the base molten, e.g., about thirty minutes, just prior to being admixed incrementally with the remaining ingredients of the gum base, if any, such as the plasticizer, fillers, and softener to plasticize the blend as well as to modulate the hardness, viscoelasticity and formability of the base. The chewing gum ingredients are next blended with the molten gum base. Mixing is continued until a uniform or homogeneous mixture of the chewing gum composition is obtained.

In another exemplary process, chewing gum ingredients are mixed with gum base without prior melting of the gum base or gum base ingredients. Mixing is continued until a uniform or homogeneous mixture of the chewing gum composition is obtained. Within this embodiment, the gum base can be in the form of a pelletized gum base that can be softened at 40 to 50° C. rather than melting at higher temperatures.

In another embodiment, a combination of melted gum base and pelletized gum base can be used.

The chewing gum composition can be prepared using a batch method or a continuous method or a combination thereof.

### Confectionery Composition Portion

The confectionery composition portion can be a candy brittle, a caramel, a chewy candy, a chocolate (dark, milk, white), carob, a compound coating, a cotton candy, a fondant, a fudge, a glaze, a gum drop candy, a gummi, a hard boiled candy, a jelly (agar, carrageenan, gelatin, konjac, pectin, or starch based), a licorice, marshmallow, a marzipan, a nougat, a praline, a taffy, a toffee, a sprinkle, or a combination thereof.

The confectionery composition can be prepared from a sugar, saccharide, or sugar-free sweetener. Exemplary sugar-based sweeteners include saccharides including mono-saccharides, di-saccharides and poly-saccharides, for example, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids, such as high fructose corn syrup, or a combination thereof.

Exemplary sugar-free sweeteners include sugar alcohols such as erythritol, galactitol, isomalt, a hydrogenated starch hydrolyzate, lactitol, maltitol, mannitol, polyglycitol, sorbitol, xylitol, and the like, or a combination thereof. The sugar alcohol can be in powdered or particulate form (either crystalline or amorphous), molten (melted) form having a low moisture content (e.g. less than 10 wt %, specifically less than 5 wt %), or in syrup form (also referred to as “solution”) with water. Exemplary sugar alcohol syrups include sorbitol syrup, maltitol syrup, hydrogenated starch hydrolysate syrup, polyglycitol syrup, and the like.

In an embodiment, the confectionery composition is sugar-free.

The confectionery composition may further comprise an additional confectionery ingredient wherein the additional confectionery ingredient can be a flavorant, a fat, a high intensity sweetener, a food acid or salt thereof, a sensate, a flavor modulator or potentiator, a coloring agent, a humectant, cocoa powder, a salt, or a combination thereof. Any of the flavorants, fats, high intensity sweetener, food acid or salt thereof, sensate, flavor modulator or potentiator, coloring agent, a salt, or humectant previously described for use to prepare the chewing gum composition can be used for the confectionery composition.

The confectionery composition can be a chocolate (dark, milk, white). In place of chocolate, the confectionery composition can be a carob composition.

The confectionery composition can be a hard boiled candy.

The confectionery composition can be a caramel.

The confectionery composition can be a chewy candy.

The confectionery composition can be a glaze.

The confectionery composition can be a gummi. “Gummi” confections (also referred to as “gummy candy”) includes a hydrocolloid texturizing agent such as gelatin alone or in combination with other texturizing agents.

The confectionery composition may comprise a hydrocolloid. Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Modified natural gums include propylene glycol alginate, carboxymethyl locust bean gum, low methoxyl pectin, or a combination thereof. Modified celluloses can be included such as microcrystalline cellulose, carboxymethlcellulose (CMC), methylcellulose (MC), hydroxypropylmethylcellulose (HPCM), hydroxypropylcellulose (MPC), or a combination thereof.

The confectionery composition can be prepared using standard techniques and equipment known in the art.

### Chewing Gum Snack Product

The chewing gum snack product is a composite of a chewing gum composition portion and a confectionery composition portion or a composite of a first chewing gum composition portion and a second chewing gum composition portion.

In an embodiment, the chewing gum snack product is a composite of a chewing gum composition portion and a confectionery composition portion, wherein the total amount of gum base is about 10 to about 40, specifically 15 to about 35 wt %; the total amount of bulk sweetener is about 25 to about 80, specifically about 35 to about 70 wt %; the total amount of fat is about 1 to about 20, specifically about 3 to about 11 wt %; and the total amount of salt is 0 to 0.75 wt %, specifically about 0.1 to about 0.60 wt % where all weights based on the total weight of the chewing gum snack product. In an embodiment, the chewing gum snack product is a composite of a chewing gum composition portion and a confectionery composition portion, wherein the amount of confectionery composition is about 10 to about 50 wt %, specifically about 15 to about 45 wt %, more specifically about 20 to about 40 wt % and yet more specifically about 25 to about 35 wt %, based on the total weight of the chewing gum snack product.

In an embodiment, the chewing gum snack product is a composite of a first chewing gum composition portion and a second chewing gum composition portion, wherein the total amount of gum base is about 35 to about 55 wt %, the total amount of bulk sweetener is about 25 to about 60 wt %, and the total amount of fat is about 5 to about 20 wt %, where all weights based on the total weight of the chewing gum snack product.

The chewing gum composition portion and the confectionery composition portion can be formed into the chewing gum snack product using a variety of processes including an extrusion process, a coextrusion process, a triple extrusion process, a laminate process, a molding process, a compression process, a rolling and scoring process, a chain die process, a rotary die process, and the like.

The chewing gum snack product can be prepared in any shape including a slab format, stick, square, chunk, a round, and the like. In an embodiment, the chewing gum snack product is formed to have a region of the chewing gum composition portion that is exposed.

In an embodiment, the chewing gum snack product has a surface of the confectionery composition portion in contiguous contact with a surface of the chewing gum composition portion. In another embodiment, the confectionery composition portion is in the form of a substrate that is in contiguous contact with a surface of the chewing gum composition portion. In another embodiment, one portion, either the confectionery composition portion or the chewing gum composition portion, is in the form of a coating partially coating the other portion. The degree of covering is less than 100% and can be about 1 to about 90% of the surface area of the portion covered, specifically about 10 to about 80%, more specifically about 20 to about 70%, yet more specifically about 30 to about 60%, and still yet more specifically about 40 to about 50%.

The confectionery composition portion can be in the form of a decorative drizzle over the chewing gum composition portion where regions of the chewing gum composition remains exposed or in the form of a glaze surrounding a part of the chewing gum composition portion or surrounding all of the portion.

The confectionery composition portion can be in the form of an inclusion within the chewing gum composition. For example, a cookie dough chewing gum can be prepared with chocolate chips randomly distributed throughout the matrix of the chewing gum composition. In addition, the cookie dough chewing gum can further include a confectionery composition coating in the form of a glaze surrounding a part of the cookie dough chewing gum portion or surrounding all of the portion.

In an embodiment, the chewing gum snack product has a surface of the first chewing gum composition portion in contiguous contact with a surface of the second chewing gum composition portion. In another embodiment, the first chewing gum composition portion is in the form of a substrate that is in contiguous contact with a surface of the second chewing gum composition portion. In another embodiment, one chewing gum composition portion, is in the form of a coating partially coating the other chewing gum portion. The degree of covering is less than 100% and can be about 1 to about 90% of the surface area of the portion covered, specifically about 10 to about 80%, more specifically about 20 to about 70%, yet more specifically about 30 to about 60%, and still yet more specifically about 40 to about 50%.

The chewing gum snack product can be formed into a piece weight of about 0.5 grams to about 8.0 grams, specifically about 1.0 grams to about 6.0 grams, specifically about 1.5 grams to about 5.0 grams, yet more specifically about 2.0 to about 4.0 grams, and yet more specifically about 2.5 grams to about 3.0 grams.

In an embodiment, the multi-textured chewing gum snack product has a non-uniform cross section. In an embodiment, the multi-textured chewing gum snack product is nonhomogeneous. Specifically, the chewing gum snack product is not a traditional slab chewing gum and is not a traditional hard or soft coated pellet chewing gum and is not a traditional gum ball. Instead, the chewing gum snack product has a chewing gum composition portion that has a different texture than a confectionery composition portion or a first chewing gum composition portion that has a different texture than a second chewing gum composition portion.

In an embodiment, a region of the chewing gum composition portion, the confectionery composition portion, or both has a surface roughness (Rₐ) of greater than 50 micrometers, specifically greater than 100 micrometers, more specifically greater than 200 micrometers.

### Sensory Analysis

Descriptive analysis is a sensory method by which the sensory attributes of a food or product are identified and quantified, using human subjects who have been specifically chosen and trained for this purpose. Once trained, a panel of evaluators will function as a human analytical instrument, generating reproducible values, rather than degrees of liking or dislike as in consumer panels.

The chewing gum snack products when evaluated for various sensory properties in comparison to traditional slab chewing gum using a panel trained in the principles of quantitative descriptive analysis (QDA) as described by Stone & Sidel (Stone & Sidel, Sensory Evaluation Practices, 3rd ed. San Diego, Calif. Elsevier Academic Press (2004)) exhibit properties that are more snack-like than chewing gum-like, particularly in the initial and early stages of the chewing process.

One attribute that is indicative of a product having more of a snack-like quality than a chewing gum-like quality is a high candy-like impression rating. Candy-like impression is a measure of how much the sample is perceived as similar to candy or similar to gum. Traditional slab chewing gum has a low candy-like impression as it gives the overwhelming impression of chewing gum.

In an embodiment, the chewing gum snack product has a candy-like impression rating upon initial chewing that is at least 20, specifically 20 to 70, and more specifically 30 to 50 points greater than a candy-like impression rating of a chewing gum slab based on a scale of 0 to 100 as measured by descriptive analysis using the Quantitative Descriptive Analysis method.

In an embodiment, the chewing gum snack product has a candy-like impression rating at 30 seconds from the start of chewing that is at least 10, specifically 10 to 35, and more specifically 15 to 25 points greater than a candy-like impression rating of a traditional chewing gum slab based on a scale of 0 to 100 as measured by descriptive analysis using the Quantitative Descriptive Analysis method.

In an embodiment, the multi-textured chewing gum snack product has a candy-like impression rating of 35 to 80 upon initial chewing based on a scale of 0 to 100 as measured by descriptive analysis using the Quantitative Descriptive Analysis method where a traditional slab chewing gum (monolithic and monotextured prepared from sorbitol, gum base, glycerol, natural and artificial flavors, less than 2% of hydrogenated starch hydrolysate, aspartame, aspartame-acesulfame, mannitol, soy lecithin, acesulfame K, colors, and butylated hydroxytoluene (BHT)) is given a rating of 10 and a multi-textured chewing gum snack product according to Example 3 is given a rating of 75.

In an embodiment, the multi-textured chewing gum snack product has a crunchy rating upon initial chewing that is at least 7.5, specifically 20 to 70, and more specifically 25 to 45 points greater than a crunchy rating of a traditional chewing gum slab based on a scale of 0 to 100 as measured by descriptive analysis using the Quantitative Descriptive Analysis method.

In an embodiment, the multi-textured chewing gum snack product has a crunchy rating at 30 seconds from the start of chewing that is at least 5.0, specifically 10 to 50, and more specifically 20 to 45 points greater than a crunchy rating of a traditional chewing gum slab based on a scale of 0 to 100 as measured by descriptive analysis using the Quantitative Descriptive Analysis method.

In an embodiment, the multi-textured chewing gum snack product has a cohesiveness rating upon initial chewing that is at least 8, specifically 10 to 50, and more specifically 20 to 45 points smaller than a cohesiveness rating of a traditional chewing gum slab based on a scale of 0 to 100 as measured by descriptive analysis using the Quantitative Descriptive Analysis method.

In an embodiment, the multi-textured chewing gum snack product has a cohesiveness rating at 5 seconds from the start of chewing that is at least 5, specifically 10 to 35, and more specifically 15 to 25 points smaller than a cohesiveness rating of a traditional chewing gum slab based on a scale of 0 to 100 as measured by descriptive analysis using the Quantitative Descriptive Analysis method.

In an embodiment, the multi-textured chewing gum snack product has a cohesiveness rating at 30 seconds from the start of chewing that is at least 5, specifically 5 to 25, and more specifically 10 to 15 points smaller than a cohesiveness rating of a traditional chewing gum slab based on a scale of 0 to 100 as measured by descriptive analysis using the Quantitative Descriptive Analysis method.

In an embodiment, the chewing gum snack product has an initial sensory texture attribute that is a non-cohesive chew and after ten minutes of chewing gives a sensory texture attribute that is a cohesive chew, and the transition from non-cohesive chew to cohesive chew is smooth.

In an embodiment, the multi-textured chewing gum snack product has a loose particulates rating upon initial chewing; that is at least 10, specifically 10 to 65, and more specifically 20 to 50 points greater than a loose particulates rating of a traditional chewing gum slab based on a scale of 0 to 100 as measured by descriptive analysis using the Quantitative Descriptive Analysis method.

In an embodiment, the multi-textured chewing gum snack product has a loose particulates rating at 30 seconds from the start of chewing that is at least 5, specifically 5 to 35, and more specifically 10 to 25 points greater than a loose particulates rating of a traditional chewing gum slab based on a scale of 0 to 100 as measured by descriptive analysis using the Quantitative Descriptive Analysis method.

In an embodiment, the multi-textured chewing gum snack product has a particle size rating upon initial chewing that is at least 8, specifically 8 to 45, and more specifically 20 to 35 points greater than a particle size rating of a traditional chewing gum slab based on a scale of 0 to 100 as measured by descriptive analysis using the Quantitative Descriptive Analysis method.

In an embodiment, the multi-textured chewing gum snack product has a particle size rating at 30 seconds from the start of chewing that is at least 5, specifically 5 to 30, and more specifically 10 to 20 points greater than a particle size rating of a traditional chewing gum slab based on a scale of 0 to 100 as measured by descriptive analysis using the Quantitative Descriptive Analysis method.

Within the embodiments described in the sensory analysis section, a region of the chewing gum composition portion can be exposed and is not completely covered by a confectionery composition portion. Within the embodiments described in the sensory analysis section, a region of the first chewing gum composition portion can be exposed and is not completely covered by the second chewing gum composition portion.

The chewing gum snack product provides a consumer with the sensation of swallowing a snack food during the initial chew process, the sensation of swallowing a snack food is distinct from the sensation of swallowing increased amounts of saliva from chewing traditional chewing gum.

In an embodiment, the multi-textured chewing gum snack product comprises a chewing gum composition portion, a confectionery composition portion, and optionally a second confectionery composition portion, a second chewing gum composition portion, or a combination thereof; the chewing gum composition portion and the confectionery composition portion have different textures; and the confectionery composition portion fractures when the multi-textured chewing gum snack product is bent 90 degrees.

In an embodiment, the multi-textured chewing gum snack product exhibits a peak bend force of greater than 400 g-force, specifically greater than 500, more specifically greater than 600, and yet more specifically greater than 700 g-force as measured using a three point bend test using e.g. a probe speed of 0.8 mm/second and a sample support distance of 30 mm. In an embodiment, the multi-textured chewing gum snack product exhibits a peak bend force that is at least five times the peak bend force exhibited by a traditional slab chewing gum.

In an embodiment, the multi-textured chewing gum snack product after chewing for about ten minutes, specifically about five minutes, results in a bolus size that is about 5 to about 15 wt %, specifically about 8 to about 12 wt % of the total starting weight of the multi-textured chewing gum snack product prior to chewing.

The multi-textured chewing gum snack product provides a sensory impression of consuming a snack product early in the chewing process, which transitions over a period of less than 120 seconds, specifically about 30 to about 90 seconds, and more specifically about 45 to about 60 seconds of chewing into a sensory impression of chewing a chewing gum. Within this embodiment, a region of the chewing gum composition portion is exposed and is not completely covered by a confectionery composition portion or a region of the chewing gum composition portion is exposed and is not completely covered by a confectionery composition portion.

The features and advantages are more fully shown by the following examples which are provided for purposes of illustration, and are not to be construed as limiting the invention in any way.

### EXAMPLES

### Example 1

### Cookie Dough (Brown Autumn Spice)

A cookie dough type product was prepared in a single bite format having a primary attribute of a soft texture, mild crunch and a graininess reminiscent of cookie dough. The cookie dough type product is prepared from a chocolate confectionery composition and a chewing gum as outlined in Tables 1. and 2. below.

TABLE 1

| Confectionery composition | |
|---|---|
| (Sugar-free chocolate) | |
| ingredient | Percentage |
| Fat High melting | 16.3 |
| Fat, melting point 55-41° C. | 13.3 |
| Mannitol | 60.4 |
| Sucralose | 0.6 |
| Cocoa powder unsweetened | 9.4 |

TABLE 2

| Chewing gum | |
|---|---|
| ingredient | Percentage |
| Isomalt | 47.1 |
| Moisture | 1.0 |
| Gum Base | 32.1 |
| Flavor | 3.3 |
| Aspartame | 0.1 |
| Acesulfame K | 0.03 |
| Sodium bicarbonate | 0.02 |
| Sugar-free chocolate pieces | 14.4 |

The process to make the sugar free chocolate involves melting fat mixture in a pot, adding mannitol, and mixing to make slurry. The slurry is transferred to a food processor and mixed for one hour to achieve smooth texture. Sucralose and cocoa are then added and mixed for an additional 15 minutes. The chocolate is deposited on a cooling table to form into pieces (“chips”).

The process to make the cookie dough chewing gum involves boiling a mixture of isomalt and water to 163° C., then cooling down to 120° C. to form a molten isomalt mass. Molten gum base is then added to the molten isomalt and mixed. Flavor and sweetener are then added in and mixed. Sodium bicarbonate is then added, mixed, and the mixture is heated to 130° C. to aerate. The aerated mass is deposited on cooling table (18° C.) and cooled until the surface is 90° C. The bottom of the mass solidifies while the top and interior are still soft. The chocolate chips are added and folded into the mass. The mass is removed from the cooling table and folded to equalize the temperature throughout the mass making it stretchable. Pull to stretch the mass. The mass is placed on a table and formed into sheets to achieve a 6 mm thickness. The sheet is then cut into 2×1.5 centimeter (cm) pieces (about 3 grams a piece).

The cookie dough type product had a texture reminiscent of cookie dough. A sensory panel characterized the sample as predominantly caramel with chocolate, nutty, coffee, and buttery notes.

### Example 2

### Cookie Dough (Glaze, Coffee Glaze)

A cookie dough type product was prepared in a single bite format having a primary attribute of a soft texture, mild crunch and a graininess reminiscent of cookie dough. The cookie dough type product is prepared from a chocolate confectionery composition, a glaze confectionery composition, and a chewing gum as outlined in Tables 3. and 4. below.

TABLE 3

| Confectionery composition | |
|---|---|
| (Caramel glaze) ingredient | Percentage |
| Isomalt | 81.0 |
| Lecithin | 0.20 |
| Cream | 6.00 |
| Butter | 8.00 |
| Preblend (flavor, isomalt, salt, | |
| and Acesulfame K) | |
| Flavor | 1.50 |
| Isomalt | 2.30 |
| Salt | 0.80 |
| Acesulfame K | 0.20 |

Process to make the glaze confectionery composition portion: Heat isomalt until molten (˜170° C.) and then cool to 130° C., add lecithin and mix until homogeneous. Butter and cream are then added and the mixture is heated to 160° C. and held for 6 minutes. The mixture is then cooled to 100° C. and then a preblend of flavor, isomalt, Acesufame K, and salt is added and mixed.

TABLE 4

| Chewing gum | |
|---|---|
| ingredient | Percentage |
| Isomalt | 47.1 |
| Moisture | 1.0 |
| Gum Base | 32.1 |
| Flavor | 3.3 |
| Aspartame | 0.1 |
| Acesulfame K | 0.03 |
| Sodium bicarbonate | 0.02 |
| Sugar-free chocolate pieces | 14.4 |

The process to make the cookie dough chewing gum involves boiling a mixture of isomalt and water to 163° C., then cooling down to 120° C. to form a molten isomalt mass. Molten gum base is then added to the molten isomalt and mixed. Flavor and sweetener are then added in and mixed. Sodium bicarbonate is then added, mixed, and the mixture is heated to 130° C. to aerate. The aerated mass is deposited on cooling table (18° C.) and cooled until the surface is 90° C. The bottom of the mass solidifies while the top and interior are still soft. The chocolate chips are added and folded into the mass. The temperature of the mass is allowed to equalize making it stretchable. Pull to stretch the mass. The mass is placed on a table and formed into sheets to achieve a 6 mm thickness. The sheet is then cut into 2×1.5 centimeter (cm) pieces (about 3 grams a piece). The pieces are coated with the coffee glaze to result in a product containing 66 wt % chewing gum and 33 wt % confectionery (chocolate+glaze).

The cookie dough type product had a texture reminiscent of cookie dough and the glaze provides an added crunchy element. A sensory panel characterized the sample as predominantly caramel with chocolate, nutty, coffee, and buttery notes.

### Example 3

### Breakables (Fruit Caramel Pear)

A candy bar type product was prepared having a multiple bite format with a primary attribute of crunchy and secondary attribute of sweet or sweet/salty, and tertiary attribute of multiflavors; highly aromatic. The Breakables (Fruit Caramel Pear) candy bar type product is prepared from a chewing gum composition and a caramel confectionery composition as outlined in Tables 5. and 6. below, and in a weight ratio of 47:53 confectionery composition:chewing gum.

TABLE 5

| Chewing gum | |
|---|---|
| ingredient | Percentage |
| Gum base | 30.0 |
| Softeners | 8.00 |
| Polyols | 56.4 |
| Flavor | 2.50 |
| Encapsulated Aspartame | 2.4 |
| Encapsulated Acesulfame K | 0.60 |
| Sucralose | 0.06 |
| Color | 0.04 |

TABLE 6

| Confectionery composition | |
|---|---|
| (Caramel/hard candy) | |
| ingredient | Percentage |
| Isomalt | 81.0 |
| Lecithin | 0.20 |
| Cream | 6.00 |
| Butter | 8.00 |
| Preblend (flavor, isomalt, salt, | |
| and Acesulfame K) | |
| Flavor | 1.50 |
| Isomalt | 2.30 |
| Salt | 0.80 |
| Acesulfame K | 0.20 |

Process to make chewing gum composition portion: Add molten gum base to a kettle. Add softeners and mix for 3-5 minutes. Add 50% of the polyols to the batch and mix for 2 minute, then add the remaining polyols and flavor to the batch and mix for 3 minutes. Add the encapsulated sweeteners to the batch and mix. The final mixture is rolled to a desired thickness.

Process to make confectionery composition portion: Heat isomalt until molten (˜170° C.) and then cool to 130° C., add lecithin and mix until homogeneous. Butter and cream are then added and the mixture is heated to 160° C. and held for 6 minutes. The mixture is then cooled to 100° C. and then a preblend of flavor, isomalt, Acesufame K, and salt is added and mixed. The mixture is transferred to a cooling table, cooled and rolled gradually into the desired thickness.

The breakables product is formed into individual pieces containing a single base layer of confectionery composition (substrate) and two or three squares of chewing gum positioned on top of the base layer (“bar format”). Alternatively, the product can be formed into individual pieces containing a single base layer of confectionery composition (substrate) and two or three long rectangular stick pieces of chewing gum positioned on top of the base layer (“stick format”). A drizzle of caramel confectionery composition is applied over the composite. The formed product can be broken into smaller pieces by hand prior to consumption or eaten whole. The break specifically occurs in a gap between the chewing gum portions such that only the confectionery composition portion needs to be broken in order to form the smaller pieces.

A sensory panel characterized the sample as predominantly caramel and buttery with slight chocolate, coffee and nutty notes.

### Example 4

### Breakables (Brown Caramel Marshmallow)

A candy bar type product was prepared having a multiple bite format with a primary attribute of crunchy, secondary attribute of sweet (sweet/salty), and tertiary attribute of multiflavors, highly aromatic. The Breakables (Brown Caramel Marshmallow) candy bar type product is prepared from a chewing gum composition and a caramel confectionery composition as outlined in Tables 7. and 8. below and in a weight ratio of 47:53 confectionery composition:chewing gum.

TABLE 7

| Chewing gum ingredient | Percentage |
|---|---|
| Gum base | 30.0 |
| Softeners | 8.0 |
| Polyols | 56.4 |
| Flavor | 2.50 |
| Encapsulated Aspartame | 2.4 |
| Encapsulated Acesulfame K | 0.60 |
| Sucralose | 0.06 |
| Color | 0.04 |

TABLE 8

| Caramel/hard candy | |
|---|---|
| ingredient | Percentage |
| Isomalt | 81.00 |
| Lecithin | 0.20 |
| Cream | 6.00 |
| Butter | 8.00 |
| Preblend (flavor, isomalt, salt, | |
| and Acesulfame K) | |
| Flavor | 1.50 |
| Isomalt | 2.30 |
| Salt | 0.80 |
| Acesulfame K | 0.20 |

Processes to make the chewing gum composition portion and confectionery composition portion are similar to those in Example 3. A sensory panel characterized the sample as predominantly caramel and buttery with slight chocolate, coffee and nutty notes.

### Example 5

### Indulgent (Fruit Orange Creamsicle)

A candy bar type product was prepared in a single bite format having a soft texture and an indulgent flavor. The Indulgent (Fruit Orange Creamsicle) candy bar type product is prepared from an indulgent chewing gum composition and a crunchy chewing gum composition as outlined in Tables 9. and 10. below, in a weight ratio of 53:47 indulgent chewing gum:crunchy chewing gum.

TABLE 9
Gum center

| Chewing gum A, Indulgent | |
|---|---|
| Ingredient | Percentage |
| Gum base | 57.50 |
| Low Melting point Fat | 20.00 |
| Xylitol, Powder | 13.00 |
| Flavor | 3.00 |
| Encapsulated Aspartame | 2.50 |
| Encapsulated Acesulfame K | 1.00 |
| Sucralose | 0.30 |
| Salt | 0.04 |

TABLE 10
Outer shell

| Chewing gum B, Crunchy | |
|---|---|
| Ingredient | Percentage |
| Isomalt | 54.61 |
| Water | 15.00 |
| Gum base | 26.00 |
| Preblend (flavor, isomalt) | |
| Isomalt | 1.50 |
| Flavor | 2.50 |
| Sucralose | 0.06 |
| Acesulfame K | 0.08 |
| Aspartame | 0.25 |

The process to make the Chewing gum A, indulgent chewing gum composition involves adding melted low melting point fat gradually to molten gum base. The mixture is mixed well until smooth. The process is repeated until the low melting point fat has been depleted. Add 50% of the xylitol and 50% of the flavor to the mixture and mix, repeat step to add remaining xylitol and flavor. Allow mixture to run for 3 minutes. The remaining sweeteners are added to the batch and mixed for 3 minutes.

The process to make the Chewing gum B, crunchy chewing gum composition involves adding water and isomalt together and heating to 170° C. to remove free water. The molten isomalt is cooled to 150° C. and molten gum base is added to the molten isomalt and the batch is mixed until homogeneous. The batch is then cooled to 90° C. and the flavor-isomalt preblend is added with mixing. The remaining sweetener is added and the mass is transferred to cooling table. The mass is rolled gradually into a desired thickness.

The formation of the indulgent product involves wrapping a piece of crunchy gum around a piece of indulgent chewing gum so that the indulgent chewing gum is exposed on two ends of the product. The crunchy chewing gum of the outer shell provides a candy-like crunch which then chews into a chewing gum texture. The indulgent chewing gum center provides a soft “creamy” mouthfeel.

### Example 6

### Indulgent (Brown Autumn Spice/Coco Pretzel)

A candy bar type product was prepared in a single bite format having a soft texture and an indulgent flavor. The Indulgent (Brown Autumn Spice/Coco Pretzel) candy bar type product is prepared from an indulgent chewing gum composition and a crunchy chewing gum composition as outlined in Tables 11. and 12. below, in a weight ratio of 53:47 indulgent chewing gum:crunchy chewing gum.

TABLE 11
Gum Center

| Chewing gum A, Indulgent | |
|---|---|
| Ingredient | Percentage |
| Gum base | 57.50 |
| LM Fat | 20.00 |
| Xylitol, Powder | 13.00 |
| Flavor | 3.00 |
| Encapsulated Aspartame | 2.50 |
| Encapsulated Acesulfame K | 1.00 |
| Sucralose | 0.30 |
| Salt | 0.04 |

TABLE 12
Outer shell

| Chewing gum B, Crunchy | |
|---|---|
| Ingredient | Percentage |
| Isomalt | 54.61 |
| Water | 15.00 |
| Gum base | 26.00 |
| Preblend (flavor, isomalt) | |
| Isomalt | 1.50 |
| Flavor | 2.50 |
| Sucralose | 0.06 |
| Acesulfame K | 0.08 |
| Aspartame | 0.25 |

The processes to make the Chewing gum A, indulgent chewing gum composition and Chewing gum B, crunchy chewing gum composition are the same as in Example 5.

The crunchy chewing gum of the outer shell provides a candy-like crunch which then chews into a chewing gum texture. The indulgent chewing gum center provides a soft “creamy” mouthfeel.

### Example 7

### Candy Bar (Brown Coco Caramel Crunch)

A candy bar type product was prepared in a single bite format having a moderate crunch and an indulgent flavor.

The product is prepared with top and bottom layers of sugar-free indulgent chewing gum such as Chewing gum A of Example 5, encasing a middle layer of a heterogeneous mixture of sugar-based chewy candy and crunchy balls of crunchy chewing gum such as Chewing gum B in Example 5. A chocolate drizzle is optionally applied to the top of the pieces. The product has a weight ratio of 18:82 confectionery composition to chewing gum.

A sensory panel characterized the sample as predominantly caramel with chocolate, nutty, coffee, and buttery notes.

### Example 8

### Sensory Measurements: Descriptive Analysis

Various sensory properties of samples of multi-textured chewing gum snack products were investigated using a panel trained in the principles of quantitative descriptive analysis (QDA) as described by Stone & Sidel (Stone & Sidel, Sensory Evaluation Practices, 3rd ed. San Diego, Calif. Elsevier Academic Press (2004)).

TABLE 13

| Sample | Description |
|---|---|
| Candy bar Brown Coco Caramel | Example 7 |
| Crunch | |
| Breakables Brown Caramel | Example 4 |
| Marshmallow | |
| Cookie Dough Glaze, Coffee Glaze | Example 2 |
| Indulgent Fruit Orange Creamsicle | Example 5 |
| Cookie Dough Brown Autumn | Example 1 |
| Spice | |
| Indulgent Brown Autumn Spice/ | Example 6 |
| Coco Pretzel | |
| Breakables Fruit Caramel Pear | Example 3 |
| Comparative fruit chewing gum | Trident ® Layers ™ Strawberry/ |
| | citrus, Chewing gum having two |
| | outer layers of chewing gum material |
| | sandwiching a center layer of |
| | flavored candy |
| Comparative pellet chewing gum | Trident ® Vitality ™ citrus- |
| | strawberry, a hard coated pellet |
| | chewing gum containing liquid |
| | centerfill |
| Comparative slab chewing gum | Traditional slab chewing gum, mint- |
| | chocolate flavored |

Seven multi-textured chewing gum snack products were prepared and tested for attributes of candy-like impression, crunch, cohesiveness, loose particulates, and particle size (Table 13). Three comparative chewing gums were also included in the study:

Trident® Layers™ Strawberry/citrus, a chewing gum having two outer layers of chewing gum material sandwiching a center layer of flavored candy (“Comparative fruit chewing gum”) 1 stick=2.5 grams, Ingredients: Gum Base, Maltitol, Maltitol Syrup, Sorbitol, Natural and Artificial Flavoring, Mannitol, Less than 2% of: Acesulfame Potassium, Aspartame, Gelatin, Partially Hydrogenated Coconut Oil, Red 40, Red 40 Lake, Soy Lecithin and Sucralose.

Trident® Vitality™ citrus-strawberry, a hard coated pellet chewing gum containing liquid centerfill (“Comparative pellet chewing gum”) 1 piece=2.0 grams, Ingredients: Isomalt, gum base, maltitol syrup, maltitol, natural and artificial flavoring sorbitol; less than 2% of: acacia, acesulfame potassium, aspartame, candelilla wax, glycerin, sodium ascorbate, soy lecithin, sucralose, titanium dioxide, xanthan gum, yellow 5 lake and yellow 6 lake.

Traditional slab chewing gum mint-chocolate flavored (“Comparative slab chewing gum”), 1 stick=2.7 grams; Ingredients: sorbitol, gum base, glycerol, natural and artificial flavors, less than 2% of hydrogenated starch hydrolysate, aspartame, aspartame-acesulfame, mannitol, soy lecithin, acesulfame K, artificial colors, and butylated hydroxytoluene (BHT).

Methodology: The samples were evaluated by a panel of trained sensory assessors. The vocabulary was generated via a 2-hour language development session. Eleven QDA panelists evaluated three samples per session. The samples were assessed four times for their aroma, initial flavor and texture, flavor, texture and mouth feel at initial, 1 minute, 5 minutes, and 10 minutes, with a 1 minute aftertaste. The order of sample presentation was randomized across assessors. Serving size: one piece. Length of chew: 10 minutes with 1 minute aftertaste. All attributes were rated on an unstructured line scale, then electronically quantified on a 100-point scale. Results were collected via the SIMS (Sensory Information Management System) and were analyzed with Tragon QDA® software using analysis of variance (ANOVA). The Duncan minimum significant difference was calculated in order to determine for each attribute, those samples, which were significantly different (p<0.05). The assessors provided input on characteristics including a variety of texture/mouthfeel attributes such as candy-like impression, crunch, cohesiveness, loose particulates, and particle size; a variety of aroma attributes; and a variety of flavor attributes.

The texture/mouthfeel attributes were useful indicators of whether a product exhibited more snack-like characteristics as opposed to more chewing gum-like characteristics.

The candy-like impression was evaluated at time “initial” and 30 seconds after start of chewing. Crunchy was only evaluated up to one minute when difference of crunchy versus noncrunchy became less. Cohesiveness was evaluated up to ten minutes when all the samples had similar cohesiveness. However, the cohesiveness of the examples was quite different before one minute and ten minutes compared to the cohesiveness of the comparative examples before one minute and at ten minutes.

The attribute definitions were as follows:

### Initial Texture/Mouthfeel

Instructions: For initial hardness, crumble, crystal particulates the sample should be placed in the side of the mouth and bitten with the side teeth:

| Attribute | Definition |
|---|---|
| CANDY-LIKE | Measure of how much the sample is |
| (gumlike-candy-like) | perceived as similar to candy or similar |
| | to gum. |
| INITIAL CRUNCH | Degree of crunching sound the sample |
| (slightly-very) | makes upon chewing, from slightly to |
| | very loud/crunchy. |
| COHESIVE | Degree of compactness of the gum and |
| (falls apart/stringy-very | to which the chewed sample holds tight |
| cohesive) | together in a mass. |
| LOOSE PARTICLES | Measure of the amount of loose |
| (some-many) | particles that are floating around the |
| | mouth or throat (even though the gum is |
| | holding together), from note to many. |
| | Reminiscent of RAZZLES. |
| INITIAL PARTICLE SIZE | Measure of size of particulates felt in |
| (small-large) | the mouth. |

Instructions: Continue chewing 3-5 times to evaluate the following:

| Attribute | Definition |
|---|---|
| COHESIVE | Degree of compactness of the gum and |
| (falls apart/stringy-very | to which the chewed sample holds tight |
| cohesive) | together in a mass. |

Continue to chew and rate the following attributes at 30 seconds.

| Attribute | Definition |
|---|---|
| CRUNCH | Degree of crunching sound the sample |
| (slightly-very) | makes upon chewing, from slightly to |
| | very loud/crunchy. |
| LOOSE PARTICLES | Measure of the amount of loose particles |
| (some-many) | that are floating around the mouth or |
| | throat (even though the gum is holding |
| | together), from note to many. |
| | Reminiscent of RAZZLES. |
| INITIAL PARTICLE SIZE | Measure of size of particulates felt in |
| (small-large) | the mouth from small to large. |
| CANDY-LIKE | Measure of how much the sample is |
| (gumlike-candy-like) | perceived as similar to candy or similar |
| | to gum. |

### Texture/Mouthfeel

Instructions: Continue chewing the sample to evaluate the following texture attributes:

| Attribute | Definition |
|---|---|
| CRUNCH | Degree of crunching sound the sample |
| (slightly-very) | makes upon chewing, from slightly to |
| | very loud/crunchy. |
| PARTICLE SIZE | Measure of size of particulates felt in |
| (small-large) 1 minute | the mouth from small to large. |
| COHESIVE | Degree of compactness of the gum and |
| (falls apart/stringy-very | to which the chewed sample holds tight |
| cohesive) | together in a mass. |

Tables 14.-18. provide the results of the sensory study.

TABLE 14
Candy-like Impression

| Sample | Initial | 30 seconds |
|---|---|---|
| Candy bar Brown Coco Caramel Crunch | 52.19 | 20.99 |
| Breakables Brown Caramel Marshmallow | 74.54 | 44.90 |
| Cookie Dough Glaze, Coffee Glaze | 48.27 | 22.70 |
| Indulgent Fruit Orange Creamsicle | 60.60 | 33.47 |
| Cookie Dough Brown Autumn Spice | 35.24 | 21.56 |
| Indulgent Brown Autumn Spice/Coco Pretzel | 55.85 | 26.40 |
| Breakables Fruit Caramel Pear | 75.75 | 44.39 |
| Comparative fruit chewing gum | 11.43 | 8.02 |
| Comparative pellet chewing gum | 22.44 | 12.24 |
| Comparative slab chewing gum | 9.76 | 9.86 |

TABLE 15
Crunchy Impression

| | | 30 | 60 |
|---|---|---|---|
| Sample | Initial | seconds | seconds |
| Candy bar Brown Coco Caramel Crunch | 33.10 | 13.63 | 5.86 |
| Breakables Brown Caramel Marshmallow | 81.06 | 54.84 | 18.09 |
| Cookie Dough Glaze, Coffee Glaze | 42.60 | 21.80 | 8.56 |
| Indulgent Fruit Orange Creamsicle | 66.67 | 42.11 | 12.81 |
| Cookie Dough Brown Autumn Spice | 15.32 | 7.89 | 4.74 |
| Indulgent Brown Autumn Spice/Coco Pretzel | 56.45 | 33.53 | 10.63 |
| Breakables Fruit Caramel Pear | 75.05 | 50.76 | 16.59 |
| Comparative fruit chewing gum | 4.76 | 4.45 | 3.97 |
| Comparative pellet chewing gum | 59.90 | 31.49 | 7.59 |
| Comparative slab chewing gum | 4.72 | 8.97 | 4.19 |

TABLE 16
Cohesiveness Impression

| | | 5 | 30 | 60 | 5 | 10 |
|---|---|---|---|---|---|---|
| Sample | Initial | seconds | seconds | seconds | minutes | minutes |
| Candy bar Brown | 45.22 | 65.05 | 70.41 | 76.02 | 78.42 | 79.31 |
| Coco Caramel | | | | | | |
| Crunch | | | | | | |
| Breakables Brown | 29.39 | 46.25 | 57.18 | 73.24 | 77.28 | 79.03 |
| Caramel Marsh- | | | | | | |
| mallow | | | | | | |
| Cookie Dough | 48.12 | 66.49 | 71.19 | 74.57 | 75.74 | 76.21 |
| Glaze, Coffee | | | | | | |
| Glaze | | | | | | |
| Indulgent Fruit | 28.35 | 51.52 | 61.41 | 72.80 | 79.12 | 81.02 |
| Orange Creamsicle | | | | | | |
| Cookie Dough | 55.97 | 67.44 | 71.29 | 72.50 | 77.33 | 79.66 |
| Brown Autumn | | | | | | |
| Spice | | | | | | |
| Indulgent Brown | 35.86 | 58.72 | 67.34 | 75.28 | 77.55 | 78.14 |
| Autumn Spice/ | | | | | | |
| Coco Pretzel | | | | | | |
| Breakables Fruit | 32.11 | 51.88 | 61.90 | 77.55 | 78.18 | 78.99 |
| Caramel Pear | | | | | | |
| Comparative fruit | 75.70 | 81.55 | 81.50 | 81.19 | 80.44 | 80.31 |
| chewing gum | | | | | | |
| Comparative pellet | 58.72 | 69.95 | 74.58 | 79.75 | 78.78 | 79.19 |
| chewing gum | | | | | | |
| Comparative slab | 71.72 | 78.13 | 78.94 | 79.83 | 79.71 | 79.54 |
| chewing gum | | | | | | |

TABLE 17
Loose Particulates Impression

| Sample | Initial | 30 seconds |
|---|---|---|
| Candy bar Brown Coco Caramel Crunch | 28.76 | 14.41 |
| Breakables Brown Caramel Marshmallow | 60.61 | 34.21 |
| Cookie Dough Glaze, Coffee Glaze | 34.32 | 15.94 |
| Indulgent Fruit Orange Creamsicle | 58.66 | 30.04 |
| Cookie Dough Brown Autumn Spice | 23.60 | 9.41 |
| Indulgent Brown Autumn Spice/Coco Pretzel | 52.03 | 23.54 |
| Breakables Fruit Caramel Pear | 62.52 | 32.32 |
| Comparative fruit chewing gum | 3.04 | 3.04 |
| Comparative pellet chewing gum | 27.92 | 13.56 |
| Comparative slab chewing gum | 3.01 | 2.70 |

TABLE 18
Particle Size Impression

| | | 30 | 60 |
|---|---|---|---|
| Sample | Initial | seconds | seconds |
| Candy bar Brown Coco Caramel Crunch | 28.47 | 13.33 | 5.52 |
| Breakables Brown Caramel Marshmallow | 43.90 | 28.29 | 12.38 |
| Cookie Dough Glaze, Coffee Glaze | 23.75 | 15.60 | 5.16 |
| Indulgent Fruit Orange Creamsicle | 44.19 | 26.84 | 9.50 |
| Cookie Dough Brown Autumn Spice | 17.60 | 10.39 | 4.45 |
| Indulgent Brown Autumn Spice/Coco Pretzel | 39.16 | 21.56 | 9.44 |
| Breakables Fruit Caramel Pear | 45.69 | 26.51 | 12.21 |
| Comparative fruit chewing gum | 3.66 | 3.35 | 3.14 |
| Comparative pellet chewing gum | 20.96 | 12.35 | 6.44 |
| Comparative slab chewing gum | 3.26 | 2.86 | 2.60 |

The results of the sensory study revealed the attributes contributing most to a candy-like impression were initial break/fracture, multi-textural experience, crunchy, loose particulates, particle size, and cohesiveness. Also, samples perceived as initially least cohesive and highest in the attributes previously mentioned gave the highest candy-like impression. In comparison, the comparative fruit chewing gum and slab chewing gum scored very low in candy-like impression. The comparative pellet chewing gum also scored fairly low in candy-like impression, instead giving an impression of a chewing gum product.

Changes in the attributes of candy-like impression, crunchy, and cohesive impression were indicative of a transition over time of a snack-like texture to an eventual texture of chewing gum as much of the confectionery portion is consumed and swallowed.

### Example 9

### Flexural Strength

The flexural strength (bend strength) of a chewing gum snack product and a comparative traditional chewing gum stick was measured. The chewing gum snack product tested was the candy bar type rectangular stick piece of Example 3 containing a caramel drizzle. The comparative sample was a stick of traditional chewing gum, a chewing gum without a confectionery composition portion and without a second chewing gum composition portion.

The test method is a three point bend test. The sample is placed across two supports distanced 30 mm apart and a probe speed of 0.8 mm/second is used. The probe is TA-92 blade probe from Texture Technologies, Scarsdale, N.Y. Bend force (the sample's resistance to bending), displacement (probe movement), and time are measured. The sample of Example 3 was tested two ways: the chewing gum side facing the probe and the confectionery side facing the probe. The magnitudes of the maximum bend force for both measurements of Example 3 were much higher than the maximum bend force for the comparative chewing gum by a factor of 5 or more. There are multiple peaks for Example 3 versus only one for the comparative chewing gum and the peaks are much sharper than the comparative gum, thus showing the chewing gum snack product is more brittle and the consumer experiences multiple breaks in initial chews. The enhanced brittleness of gums like Example 3 is also demonstrated by its lower bending deformation (less probe movement) before break. Compared to the comparative chewing gum, Example 3 had about half as much bending deformation before break.

The above described test can also be used with samples less than 30 mm long by moving the supports towards each other so that the sample rests on both supports so that about 15% of the sample length extends over each support.

As used herein the terms “comprising” (also “comprises,” etc.), “having,” and “including” is inclusive (open-ended) and does not exclude additional, unrecited elements or method steps. The singular forms “a,” “an,” and “the” include plural referents unless the context clearly dictates otherwise. The endpoints of all ranges directed to the same characteristic or component are independently combinable, and inclusive of the recited endpoint. The term “a combination thereof” is inclusive two or more components of the list. The term “homogeneous” refers to a uniform blend of the components. The terms “first,” “second,” and the like, “primary,” “secondary,” and the like, as used herein do not denote any order, quantity, or importance, but rather are used to distinguish one element from another.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A multi-textured chewing gum snack product, comprising:
a.) a chewing gum composition portion and a confectionery composition portion, the chewing gum composition portion having a different texture than the confectionery composition portion; or
b.) a first chewing gum composition portion and a second chewing gum composition portion, the first chewing gum composition portion having a different composition and different texture than the second chewing gum composition portion; and
the multi-textured chewing gum snack product has a candy-like impression rating upon initial chewing that is at least 20 points greater than a candy-like impression rating of a chewing gum slab based on a scale of 0 to 100 as measured by descriptive analysis using the Quantitative Descriptive Analysis method.

2. The multi-textured chewing gum snack product of claim 1, wherein
the multi-textured chewing gum snack product has a candy-like impression rating at 30 seconds from the start of chewing that is at least 10 points greater than a candy-like impression rating of a traditional chewing gum slab based on a scale of 0 to 100 as measured by descriptive analysis using the Quantitative Descriptive Analysis method.

3. The multi-textured chewing gum snack product of claim 1, comprising:
a.) a chewing gum composition portion and a confectionery composition portion, the chewing gum composition portion having a different texture than the confectionery composition portion; or
b.) a first chewing gum composition portion and a second chewing gum composition portion, the first chewing gum composition portion having a different composition and different texture than the second chewing gum composition portion; and
the multi-textured chewing gum snack product has a candy-like impression rating of 35 to 100 upon initial chewing based on a scale of 0 to 100 as measured by descriptive analysis using the Quantitative Descriptive Analysis method where a traditional slab chewing gum that is monolithic and monotextured and prepared from sorbitol, gum base, glycerol, natural and artificial flavors, less than 2% of hydrogenated starch hydrolysate, aspartame, aspartame-acesulfame, mannitol, soy lecithin, acesulfame K, colors, and butylated hydroxytoluene is given a rating of 10 and a multi-textured chewing gum snack product according to Example 3 is given a rating of 75.

4. The multi-textured chewing gum snack product of claim 1, comprising:
a.) a chewing gum composition portion and a confectionery composition portion, the chewing gum composition portion having a different texture than the confectionery composition portion; or
b.) a first chewing gum composition portion and a second chewing gum composition portion, the first chewing gum composition portion having a different composition and different texture than the second chewing gum composition portion; and
the multi-textured chewing gum snack product has a candy-like impression rating of 20 to 100 upon initial chewing based on a scale of 0 to 100 as measured by descriptive analysis using the Quantitative Descriptive Analysis method where a traditional slab chewing gum that is monolithic and monotextured and prepared from sorbitol, gum base, glycerol, natural and artificial flavors, less than 2% of hydrogenated starch hydrolysate, aspartame, aspartame-acesulfame, mannitol, soy lecithin, acesulfame K, colors, and butylated hydroxytoluene is given a rating of 10 and a multi-textured chewing gum snack product according to Example 3 is given a rating of 75;
wherein a region of the chewing gum composition portion is exposed.

5. The multi-textured chewing gum snack product of claim 1, comprising:
a.) a chewing gum composition portion and a confectionery composition portion, the chewing gum composition portion having a different texture than the confectionery composition portion; or
b.) a first chewing gum composition portion and a second chewing gum composition portion, the first chewing gum composition portion having a different composition and different texture than the second chewing gum composition portion; and
wherein the multi-textured chewing gum snack product exhibits a peak bend force of greater than 400 g-force as measured using a three point bend test.

6. The multi-textured chewing gum snack product of claim 1, wherein
the confectionery composition portion fractures when the multi-textured chewing gum snack product is bent 90 degrees.

7. (canceled)

8. The multi-textured chewing gum snack product of claim 1, comprising:
a.) a chewing gum composition portion and a confectionery composition portion, the chewing gum composition portion having a different texture than the confectionery composition portion; or
b.) a first chewing gum composition portion and a second chewing gum composition portion, the first chewing gum composition portion having a different composition and different texture than the second chewing gum composition portion; and
the multi-textured chewing gum snack product provides a sensory impression of consuming a snack product upon initial chewing, which transitions over a period of less than 120 seconds of chewing into a sensory impression of chewing a chewing gum; and
a region of the chewing gum composition portion is exposed.

9. The multi-textured chewing gum snack product of claim 1,
having a crunchy rating upon initial chewing that is at least 7.5 points greater than a crunchy rating of a traditional chewing gum slab based on a scale of 0 to 100 as measured by descriptive analysis using the Quantitative Descriptive Analysis method; or
having a crunchy rating at 30 seconds from the start of chewing that is at least 5.0 points greater than a crunchy rating of a traditional chewing gum slab based on a scale of 0 to 100 as measured by descriptive analysis using the Quantitative Descriptive Analysis method.

10. (canceled)

11. The multi-textured chewing gum snack product of claim 1, having a cohesiveness rating upon initial chewing that is at least 8 points smaller than a cohesiveness rating of a traditional chewing gum slab based on a scale of 0 to 100 as measured by descriptive analysis using the Quantitative Descriptive Analysis method;
having a cohesiveness rating at 5 seconds from the start of chewing that is at least 5 points smaller than a cohesiveness rating of a traditional chewing gum slab based on a scale of 0 to 100 as measured by descriptive analysis using the Quantitative Descriptive Analysis method; or
having a cohesiveness rating at 30 seconds from the start of chewing that is at least 5 points smaller than a cohesiveness rating of a traditional chewing gum slab based on a scale of 0 to 100 as measured by descriptive analysis using the Quantitative Descriptive Analysis method.

12.-13. (canceled)

14. The multi-textured chewing gum snack product of claim 1, having a loose particulates rating upon initial chewing; that is at least 10 points greater than a loose particulates rating of a traditional chewing gum slab based on a scale of 0 to 100 as measured by descriptive analysis using the Quantitative Descriptive Analysis method; or
having a loose particulates rating at 30 seconds from the start of chewing that is at least 5 points greater than a loose particulates rating of a traditional chewing gum slab based on a scale of 0 to 100 as measured by descriptive analysis using the Quantitative Descriptive Analysis method.

15. (canceled)

16. The multi-textured chewing gum snack product of claim 1, having a particle size rating upon initial chewing that is at least 8 points greater than a particle size rating of a traditional chewing gum slab based on a scale of 0 to 100 as measured by descriptive analysis using the Quantitative Descriptive Analysis method; or
having a particle size rating at 30 seconds from the start of chewing that is at least 5 points greater than a particle size rating of a traditional chewing gum slab based on a scale of 0 to 100 as measured by descriptive analysis using the Quantitative Descriptive Analysis method.

17. (canceled)

18. The multi-textured chewing gum snack product of claim 1,
having a region of the chewing gum composition portion that is exposed;
wherein the chewing gum composition portion and the confectionery composition portion are visually distinct from one another, and the first chewing gum composition portion and the second chewing gum composition portion are visually distinct from one another;
wherein the chewing gum composition portion and the confectionery composition portion have different colors, and the first chewing gum composition portion and the second chewing gum composition portion have different colors; or
wherein the chewing gum composition portion and the confectionery composition portion have different shapes, sizes, or a combination thereof, and the first chewing gum composition portion and the second chewing gum composition portion have different shapes, sizes, or a combination thereof.

19.-21. (canceled)

22. The multi-textured chewing gum snack product of claim 1, wherein the multi-textured chewing gum snack product has a non uniform cross section.

23. The multi-textured chewing gum snack product of claim 1, wherein the multi-textured chewing gum snack product is nonhomogeneous.

24. The multi-textured chewing gum snack product of claim 1, wherein the chewing gum composition portion and the confectionery composition portion have different flavors, and the first chewing gum composition portion and the second chewing gum composition portion have different flavors,
each flavor is a fruit, a brown, a spice, a savory, or a combination thereof.

25. The multi-textured chewing gum snack product of claim 1, wherein
the amount of confectionery composition is about 10 to about 50 wt % based on the total weight of the chewing gum snack product.

26. The multi-textured chewing gum snack product of claim 1,
wherein the confectionery composition portion is a candy brittle, a caramel, a chewy candy, a chocolate (dark, milk, white), carob, a compound coating, a cotton candy, a fondant, a fudge, a glaze, a gum drop candy, a gummi, a hard boiled candy, a jelly (agar, carrageenan, gelatin, konjac, pectin, or starch based), a licorice, marshmallow, a marzipan, a nougat, a praline, a taffy, a toffee, a sprinkle, or a combination thereof.

27. (canceled)

28. The multi-textured chewing gum snack product of claim 1, wherein a region the chewing gum composition portion or the confectionery composition portion has a surface roughness (Rₐ) of greater than 50 micrometers.

29. (canceled)

30. The multi-textured chewing gum snack product of claim 1 comprising a chewing gum composition portion and a confectionery composition portion, wherein
the total amount of gum base is about 10 to about 40;
the total amount of bulk sweetener is about 25 to about 80,
the total amount of fat is about 1 to about 20 wt %; and
the total amount of salt is 0 to 0.75 wt %,
all weights based on the total weight of the chewing gum snack product.

31. The multi-textured chewing gum snack product of claim 1 comprising a first chewing gum composition portion and a second chewing gum composition portion, wherein
the total amount of gum base is about 35 to about 55 wt %,
the total amount of bulk sweetener is about 25 to about 60 wt %, and
the total amount of fat is about 5 to about 20 wt %,
all weights based on the total weight of the chewing gum snack product.
